(19) United States
(12) Patent Application Publication
(10) Pub. No.: US 2006/0287426 A1
(43) Pub. Date: Dec. 21, 2006

(54) Biodegradable temporary adhesion compound

(75) Inventor: Peter Harvey Burgher, Port St. Joe, FL (US)

Correspondence Address: G S H Corporation, 2624 Indian Pass Road, Port St. Joe, FL, 32456, US

(73) Assignee: GSH Corp., Port St. Joe, FL (US)

(21) Appl. No.: 11/431,579

(22) Filed: Jul. 21, 2006

Related U.S. Application Data
(60) Provisional application No. 60/688,794, filed on Jun. 9, 2005.

(51) Int. Cl. C08L 91/08

(52) U.S. Cl. 524/487

(57) ABSTRACT

A biodegradable temporary adhesion compound for use as an assembly aid, positioning aid, small part stabilizing aid, anti-vibration substance or removable adherent material. Comprised of materials that are inert when combined, the compound can be applied to tools, parts, assemblies or manually for the temporary holding thereof and easily cleaned off leaving a minimal residue when the assembly or process is completed. Application of heat to a level of 160° F. removes substantially all traces of the compound if necessary, but since it is not chemically reactive in its preferred composition removal is usually not necessary.

### TECHNICAL FIELD

This invention relates to the field of adhesives and the deliver) or application thereof.

### BACKGROUND

Adhesive materials are available in many forms, formulations and physical characteristics. Most adhesive compounds, whether aerobic or anaerobic are designed to be permanent or semi-permanent in nature. That is most adhesives are intended to join materials of various characteristics together, repair cracked, penetrated or broken components or enable use of dissimilar materials to be used where the attributes of such materials can be combined for better life, performance or mass. There are only a limited number of adhesives that are not intended to permanently join other materials together.

An example of a temporary adhesion application is the use of a non-permanent adhesive on small pieces of paper that may be written upon and temporarily “posted” in use for a future reference or reminder. Such adhesive materials are highly sophisticated and are the product of long and in-depth research. But they are limited in usefulness to their sole intended purpose.

One disadvantage of many adhesives is the existence of a remainder substance adhering to parts or elements of an “assembly”, be it paper, metal or plastic that contaminates the elements and either prevents or limits the performance of additional adhesives that might be used in reassembly. Silicon RTV, contact cement or rubber cement have such characteristics. Other adhesives, such as epoxies and various aerobic or anaerobic compounds cure and become permanent, thus preventing disassembly or removal. Many compounds require “cure time” to become adhesive and, thus, are not useful for quick application.

Relevant References Include:

(a) U.S. Pat. Nos. 6,582,791; 6,293,037; 6,132,850; 5,939,479; 5,869,556; 575,658; 5,654,387; 6,590,031; 6,284,837; 6,063,838; 5,929,167; 5,861,472; 572,846; 5,620,795; 6,593,414; 6,254,985; 6,054,213; 5,910,536; 5,856,387; 570,810; 5,602,221; 6,525,129; 6,214,931; 5,961,770; 5,883,149; 5,834,538; 568,379; 5,597,648; 6,511,744; 6,166,110; 5,952,422; 5,874,143; 5,817,426; 566,322; 5,492,950; 5,412,635
   (b) Other Reference Material:
Aquabond temporary adhesives (require hot water removal). Source Google—Eco-safe, Eco-bond advt Sep. 16, 2003
Crystal bond, water mount thermoplastic polymer, Melt Mount toluene soluble hot melt, products of Electron Miscropy Sciences, PA
3M double faced tape, carrier foam, carrier tissue, 3M Corp., MN
J. H. Young Co., Stronghold brand waxes for temporary mounting of optics, semi-conductors or ceramics, J. H. Young Company, NY
Apollo brand spray adhesives for temporary bonding, Apollo Industries, Inc., GA
Aremco temporary adhesives for textiles, Aremco Industries, NY
Cleansweep Supply Mounting Putty, UHU Tac Adhesive putty, both for paper or clean dry surfaces, Clean Sweep Supply Co., Inc. FL
Henkel Consumer Adhesives, Inc., Duck poster putty

### SUMMARY

A need exists for an adhesive compound that can be used for temporary adhesion of components during assembly, for example:

Securing a nut in the jaws of a wrench to be maneuvered to a remote small location.

Holding a screw on the tip of a finger for insertion into a tight assembly or location.

Keeping small fasteners or components in place during assembly of models, intricate or small assemblies.

Stabilizing or holding objects in a vibrating or moving environment such as a cabinet or shelf on a boat.

Temporarily retaining a clip or threaded retainer at the end of a shaft or component to be oriented in a vertical position.

Elevating small objects, coins, playing cards, etc. without manually grasping them.

Additional uses and applications should be apparent to persons with ordinary skills and knowledge of mechanical assembly techniques and component stabilization. The need for the invention exists in aviation and auto mechanics and assembly, model and prototype building, construction, plumbing, electrical wiring and assembly, electronic assembly, RV industry, boat use and construction, household uses, hardware, machine building, prestidigitation, art and office applications.

### DETAILED DESCRIPTION OF THE PREFERRED EMBODIMENT(S)

A need, therefore, exists for a compound that has the following characteristics: strong and controllable adhesion, temporary use capability, bio-degradable, relatively residue free, easily cleaned-up, and inert to human skin and metal and plastic substances.

It is the object to the present invention to meet these requirements with a compound or series of compounds that can be used with safety to humans and convenience, ease of use and reasonable cost.

A further object of the invention is to deliver the resulting temporary adhesion compound in convenient and ergonomically useful form.

A still further object is to deliver the invention in ways that will be readily useful to the many industries and applications that present themselves in need for the compound.

In carrying out the above objects, the present invention provides a substance in a form similar to a highly viscous grease-like material that can be packaged in a wide variety of deliver) systems. It is inert and colorless and will not change the color of or stain most materials into which it comes in contact.

While the formulation in the preferred embodiment is stated, by varying the proportions of the active ingredients the compound can be made more adherent or less adherent for use in applications having different demands for viscidity and for different indices of flow ability or the lack thereof.

The preferred embodiment consists of the following in the proportions stated:

| Elemental compound | Percent | |
|---|---|---|
| or ingredient | by weight | Grams/Kg. |
| PE Wax | 66.67 | 667 |
| Polybutene | 33.33 | 333 |

The component materials are heated and mixed through agitation or stirring until a homogenous compound results. While warm it can be decanted into suitable containers.

Exhaustive tests using a Cheminstruments PMA-1000 Probe Material Analyzer optimized the above formulation at an insertion force of 519 rams and an extraction force of 260 grams. Higher values were obtained by varying constituent proportions. The disclosed forces were found to be optimal by field tests.

In the preferred embodiment, the compound is non-conductive and dielectric, however, the ability to conduct an electrical current can be achieved by adding measured amounts of metallic powder or filings. Conversely, dielectric strength can be enhanced by increasing file thickness using inert additives such as glass powder or silicon dust. Colors may be added to suit using miscible petroleum based compounds. Packaging may be varied to suit the application, including pro-pel re-pel containers, flexible tubes, plunger injectors or various types of dispensing equipment.

In the preferred embodiment application of heat at a level of 160° F. or higher, and remove all but minor traces of the compound. Furthermore, application of a soft cloth or wiping rag will remove all but a small film without the use of heat. Since the compound is relatively inert inherently colorless and non-toxic, any remaining material will not distort, discolor or damage all but the most sensitive substrates.

Students of the art will find that minor changes to the formula given above will produce significant changes in performance characteristics. Moreover, exposure to heat in excess of 160° F. will render the compound devoid of most of its desired characteristics.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A temporary adhesion compound comprising PE Wax and polybutene mixed in various proportions having viscidity, inertness, bio-degradability and stability.

2. A temporary assembly methodology utilizing an adhesion compound that can be applied manually or mechanically and removed easily after assembly is completed.

3. A method of stabilizing objects or holding components in place on a vibrating or moving base utilizing a temporary adhesion compound.

4. The temporary adhesion compound of claim 1 further modified to increase or decrease viscidity.

5. The temporary adhesion compound of claim 1 further modified to change color or visibility.

6. The temporary adhesion compound of claim 1 further modified to permit electrical conductivity.

7. The temporary adhesion compound of claim 1 further modified to increase its dielectric and electrical resistance characteristics.

8. The temporary adhesion compound of claim 1 packaged in propel-repel containers for safe storage and ease of application.

9. The temporary adhesion compound of claim 1 packaged in bulk.

10. The temporary adhesion compound of claim 1 packaged in capped flexible tubes.

11. The temporary adhesion compound of claim 1 packaged in plunger injectors.

12. The temporary adhesion compound of claim 1 delivered in automated or manually operated dispensing equipment.

13. The temporary adhesion compound of claim 1 delivered in combinations of methodology and packages.
